(19) United States
(12) Patent Application Publication
(10) Pub. No.: US 2018/0323612 A1
(43) Pub. Date: Nov. 8, 2018

(54) METHODS OF OBTAINING RELIABLE OPERATION FROM UNRELIABLE POWER SOURCES

(71) Applicant: Louis Alvin Lippincott, Los Altos, CA (US)

(72) Inventor: Louis Alvin Lippincott, Los Altos, CA (US)

(21) Appl. No.: 15/587,372

(22) Filed: May 4, 2017

(51) Int. Cl. H02J 3/14; H02J 3/38; H04N 5/232

(52) U.S. Cl. CPC H02J 3/14; H04N 5/23241; H02J 3/383

(57) ABSTRACT

Methods and circuits are disclosed to allow reliable and predictable operation from unreliable and unpredictable power sources. Methods and circuits for using solar panels without batteries or large storage capacitors to power computing devices are disclosed. In addition, a birdhouse using a Wi-Fi video and audio camera powered with a solar panel is described.

### CROSS-REFERENCE TO RELATED APPLICATIONS

This application claims the benefit of and priority to the following U.S. Provisional Patent Application No. 62/391,591 filed May 4, 20164, which is incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE DISCLOSURE

This disclosure relates generally to reliably powering computing devices from unreliable or unpredictable power sources and relates specifically to reliably powering computing devices from a solar panel without the use of batteries or storage capacitors. Additionally, the disclosure describes and enables other applications for powering computing devices with unreliable or unpredictable power sources.

### BACKGROUND

The prior art method of powering computing devices uses a voltage monitoring circuit to hold the computing device in a reset state until the proper voltage level is reached. When the proper voltage level is reached the device is removed from the reset state and allowed to run. This method works fine when powering devices from charged batteries, charged capacitors, power supplies, etc. However, if the voltage builds up slowly from an unreliable power source, such as from the sun shining on a solar panel as it rises or emerges from a cloud, from water starting to flow through a pipe, from the heat buildup on two dissimilar metals, etc., then reliable operation is difficult or impossible with the prior art methods, unless batteries or large storage capacitors are used to accumulate and store the energy.

The problem with the prior art methods stems from the fact that all computing devices consume much less power when they are held in a reset state. Consequently, when the reset condition is removed and the computing device is allowed to operate, the power demands immediately and dramatically rise. When the higher power demands are placed on the power source, without batteries or storage capacitors as backup, the voltage immediately drops down. This causes the voltage monitoring circuit to place the computing device in reset again. Putting the device in reset again will cause the power demands to immediately and dramatically drop, causing the voltage monitoring circuit to place the computing device in a non-reset state again. This reset/non-reset cycling will keep happening until the power source has enough capacity to power the device in the non-reset state. However, by this time it is very likely that something went wrong during the cycling on and off of power and the device will not operate properly. Often, near the threshold between not-enough-power and enough-power, the voltage will spike down low enough to cause a failure in operation but will be too short in time to cause the reset circuit to trigger. Since the device will not be reset again until power drops, the device remains in the inoperable state.

There are applications for powering computing devices from unreliable or unpredictable power sources where it is imperative that the device work the very first time it is activated. For example, completely solid-state devices (without batteries and storage capacitors) can be made very small and inexpensive. They could be powered with a heat detecting power source where high heat causes them to turn on and activate. Such devices could be embedded in walls of homes or sprinkled throughout forests and lay dormant for decades if needed, since there are no batteries to degrade. When a fire causes the device to power on, it could transmit a signal and cause action to be taken, such as triggering an alarm. Obviously, such a device would have to work the first time, since it will not be given a second chance to operate.

Accordingly, there exists a need for methods of powering computing devices from unreliable and unpredictable power sources, without using costly and unreliable batteries and storage capacitors.

### SUMMARY

Briefly and in general terms, the present disclosure is directed towards a solar powered Wi-Fi camera placed in a birdhouse. The solar panel represents the unreliable and unpredictable power source and the Wi-Fi camera represents the computing device. A special circuit is inserted between the solar panel and the Wi-Fi camera and is used to guarantee reliable operation as the sunlight comes and goes. Throughout this disclosure the Wi-Fi camera will be referred to simply as the computing device, since it contains a processor connected to a camera sensor and has a Wi-Fi module to transmit the compressed video and audio stream. The Wi-Fi camera is placed inside a birdhouse and is powered only by solar panels. As the sun rises and shines on the solar panel(s) the camera will start operating and transmit the video and audio data to a smart phone or tablet or computer, allowing consumers to watch the birds living in their birdhouse. Since on any given day the sun comes up only once, the Wi-Fi camera has to work the very first time it is powered on.

According to one aspect, a disclosed embodiment provides methods of keeping the computing device powered off until it can be determined that the solar panel has enough sunlight shining on it to reliably run the computing device.

According to another aspect, a disclosed embodiment provides methods of keeping a dummy load engaged until it can be determined that the solar panel has enough sunlight shining on it to reliably run the computing device.

According to another aspect, a disclosed embodiment provides methods of keeping a dummy load, equal to or greater than the worst-case load from the computing device in operation, engaged until it can be determined that the solar panel has enough sunlight shining on it to reliably run the computing device.

Other features and advantages of the present disclosure will become apparent from the following detailed description, taken in conjunction with the accompanying drawings, which illustrate, by way of example, the principles of the disclosed embodiments.

### BRIEF DESCRIPTION OF THE DRAWINGS

FIG. 1 is a schematic of the typical prior art power on reset circuit.

FIG. 2 is a schematic of an improved power on circuit using a voltage monitoring component with complementary Reset outputs.

FIG. 3 is a schematic of an improved power on circuit using a voltage monitoring component without complementary Reset outputs.

FIG. 4 is a schematic of an improved power on circuit using a voltage monitoring component with complementary Reset outputs connected before a voltage regulator and utilizing a voltage regulator with an enable.

FIG. 5 is a schematic of an improved power on circuit using a voltage monitoring component with complementary Reset outputs connected after a voltage regulator.

FIG. 6 is a schematic of an improved power on circuit using a voltage monitoring component with complementary Reset outputs connected after a voltage regulator with a dummy load that is kept engaged until the Reset signal is removed from the computing device.

FIG. 7 is a timing diagram that depicts the problem with using an unreliable power source with the prior art method of power on reset.

FIG. 8 is a timing diagram that depicts using an unreliable power source with the new improved method of power on reset.

FIG. 9 is a representative schematic of an improved method of controlling computing devices circuit as it might be implemented on an Integrated Circuit.

### DETAILED DESCRIPTION

An improved electronic power control circuit is described. In the following description, numerous specific details are set forth. However, it is understood that embodiments may be practiced without these specific details. In other instances, well-known materials, structures, and techniques have not been shown in detail in order not to obscure the understanding of this description.

The terms, “for example,” “e.g.,” “in one/another aspect,” “in one/another scenario,” “in one/another version,” “in some configurations,” “in some implementations,” “preferably,” “usually,” “typically,” “may,” and “optionally,” as used herein, are intended to be used to introduce non-limiting embodiments. Unless expressly stated otherwise, while certain references are made to certain example system components or services, other components and services may be used as well and/or the example components may be combined into fewer components and/or divided into further components.

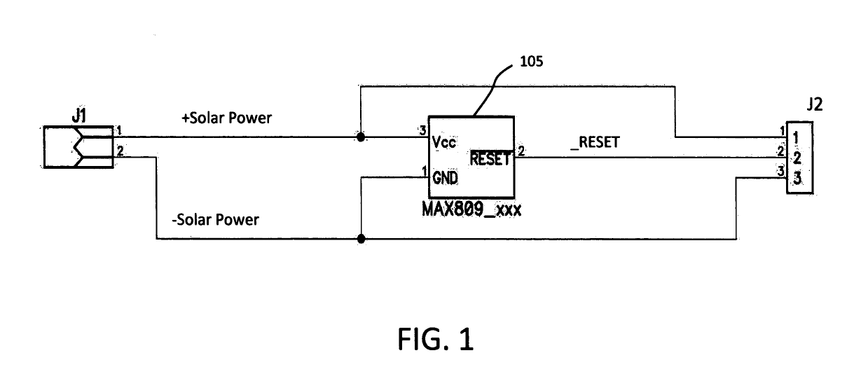

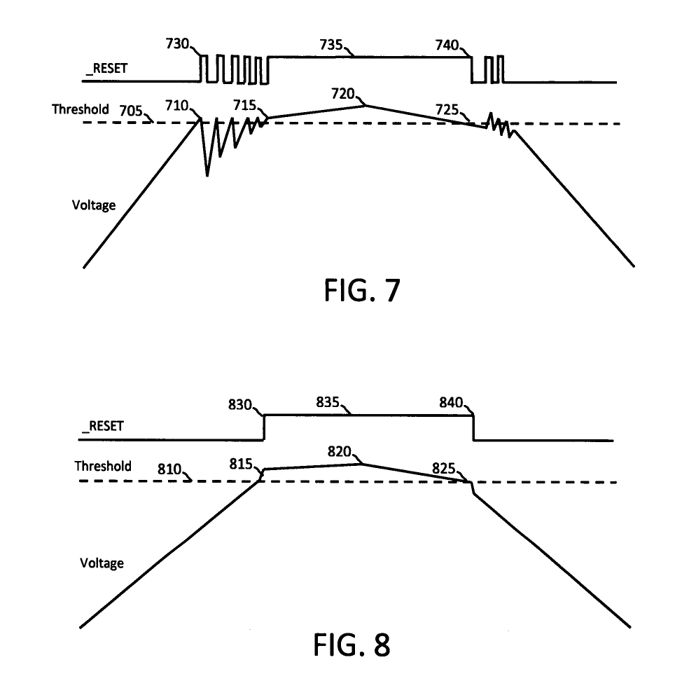

Turning now to the drawings, which are included by way of example and not limitation, the present disclosure is directed towards the typical electronic power control circuit known as the prior art method. As shown in FIG. 1 the prior art method of providing a power on reset consists of a voltage monitor circuit 105, sometimes referred to as a voltage supervisory circuit 105, and connections for a power source. Typically, power is applied and when the voltage supervisory circuit 105 detects a proper voltage level on the power source, the _RESET signal is deactivated, usually after some programmed short delay. The deactivation of the _RESET signal allows the computing device, powered through J2 in this case, to operate. If the power source has the capacity to supply enough current to the computing device then normal operation will begin. However, if the power source does not have the capacity to supply enough current at this time then the behavior depicted in the timing diagram in FIG. 7 occurs. Solar panels are especially troublesome because the open circuit voltage, i.e. with little or no load placed on them, is reached very easily without much sunlight. As soon as any significant current demand is placed on them the voltage drops dramatically until there is enough sunlight to allow proper operation of the solar panel.

When the threshold voltage is reached for the voltage supervisory circuit 105 at point 710 in FIG. 7, the _RESET signal is deactivated 730. The deactivation of the _RESET signal 730 allows the computing device to start running. All computing devices consume more power, i.e. place a higher current drain on the power source, when they are allowed to start operating. The increased load on the power source will cause the internal resistance of the power source to drop more voltage, yielding a lower voltage on the output. This drop in voltage, shown just after point 710 in the timing diagram, triggers the voltage supervisory circuit 105 to activate _RESET. As the _RESET signal is activated, the computing device stops operation, causing a drop in current demand. The drop in current demand causes the voltage to again rise, which causes the voltage supervisory circuit 105 to deactivate the _RESET signal again. This cycling of the _RESET signal repeats until the power source has enough capacity to supply the current demands of the computing device while it is operating, at point 715 in the timing diagram. In the case of a solar panel, the cycling of _RESET behavior will continue until the sun rises high enough in the sky to enable the solar panel to supply the current demands of the operating computing device, i.e. during period 735 in the timing diagram. However, because of the rapid cycling of the _RESET signal, the computing device may not work properly. There could be voltage drops caused by current spikes that were too short to be caught by the voltage supervisory circuit 105, or the various components on the computing device may not behave properly with a rapid cycling of the _RESET signal and with rapid drops in voltage. Also, the application of _RESET just after removing it allows the computing device to operate for only a short time before it is immediately stopped by the activation of the _RESET signal, causing the initialization sequence usually running first to be truncated.

After the peak in sunlight (at point 720 in the timing diagram) the capacity of a solar panel will start to decrease. At some point (725 in the timing diagram) the solar panel voltage will drop below the threshold 705 for the voltage supervisory circuit 105 and the _RESET signal will once again be activated, at point 740 in the timing diagram. Normally this would be the proper shutdown sequence for the computing device. However, as noted earlier, the current demands will drop when the computing device is placed into the reset state, causing the voltage out of the solar panel to rise. Therefore, we will get the same kind of cycling of the _RESET signal on the way to shut down as well as on the way to power up.

In any case, is has been observed by the inventor that computing devices powered by solar panels and the like, using only the prior art method of controlling the power on sequence, sometimes work properly and sometimes don't work properly. Clearly, an improved method of controlling computing devices with unreliable power sources is needed.

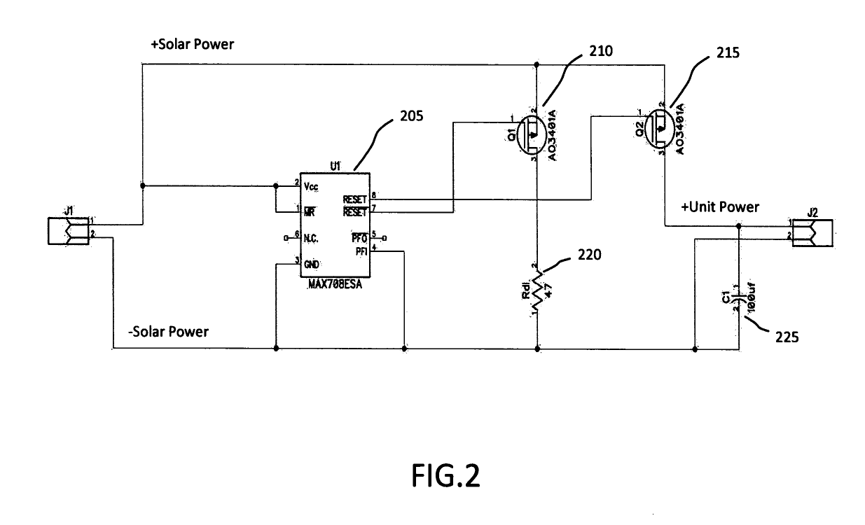

FIG. 2 shows an improved method of controlling computing devices with unreliable power sources. A voltage supervisory circuit 205 with complementary _RESET and RESET signals is used in this example. The voltage supervisory circuit 205 monitors the input supply voltage, just like in the prior art method. However, while the voltage is too low for proper operation, i.e. while the _RESET signal is active, a dummy load 220 equal to or greater than the worst case computing device's operating load is kept engaged through a MOS-FET switch 210. At the same time, a MOS-FET switch 215 keeps the computing device (powered through J2) in the powered off state. In other words, while the voltage is too low, the dummy load is powered and the computing device is not powered. A filter capacitor 225 can be in place to suppress voltage transients on the output, but is not needed in every implementation of the circuit. It will depend on the specifics of the implementation and is easily determined by anyone skilled in the art of electronic design.

The timing diagram of FIG. 8 shows the behavior of the improved method of controlling computing devices with unreliable power sources, such as from the circuit in FIG. 2.

Initially, during the design of the circuit, a dummy load equal to or greater than the worst case load during the operating state of the computing device is calculated and a resistor value for the dummy load 220 is selected. For example, if the threshold voltage is 5 volts and the maximum current draw from the operating state of the computing device is 100 ma then the resistor value would be 5 volts divided by 0.100 Amps, or 50 ohms. The few milliohms of resistance of the MOS-FET switches 210 and 215 can usually be ignored.

As the voltage rises the current draw will continually increase because of the resistive load of the dummy load 220. Therefore, it takes longer for the solar panel to come up to operating voltage 810 at point 815 in the timing diagram. However, with the improved method of controlling computing devices with unreliable power sources, when the _RESET signal is deactivated 830 the dummy load 220 is also released by turning off MOS-FET switch 210 and turning on MOS-FET switch 215. The instantaneous release of the dummy load 220 causes an immediate rise in output voltage from the solar panel at point 815 in the timing diagram. The rise in voltage is caused from removing a worst case load, i.e. the dummy load 220, and applying a typical load from the computing device. Since the computing device can never draw more current than the worst case load, the voltage never drops below the voltage threshold 810 while being powered up. The immediate rise in voltage when the dummy load 220 is released has the added benefit of creating hysteresis (voltage margin) naturally. Now the computing device can operate normally during the period 835 that the sun provides enough light to operate the computing device.

After the sun peaks at point 820 and starts to decline in light intensity it will reach a point where it can no longer supply enough energy to power the computing device in operation (at point 825 in the timing diagram). At this point the _RESET signal is asserted and the dummy load is engaged through MOS-FET 210 while powering down the computing device through MOS-FET device 215. The instantaneous engagement of the dummy load 220 causes an immediate drop in output voltage from the solar panel at point 825 in the timing diagram. The drop in voltage is caused from adding a worst case load, i.e. the dummy load 220, and removing a typical load from the computing device. Since the computing device draws less current than the worst case load, the voltage never rises above the voltage threshold 810 while being powered down. The immediate drop in voltage when the dummy load 220 is engaged has the added benefit of creating hysteresis (voltage margin) naturally. Now the computing device can power down normally during the period after point 825 that the sun does not provide enough light to operate the computing device.

In summary, the circuit in FIG. 2 provides an improved method of controlling computing devices with unreliable power sources during both the power on sequence and the power off sequence. This reliable on/off operation is especially important for solar panel powered devices since in reality the sun is often partially or completely blocked by clouds that come and go with the wind.

All of the circuits discussed below offer an improved method of controlling computing devices with unreliable power sources that use essentially the same method previously described, where a dummy load is engaged until the computing device is powered on or allowed to operate. Various themes of the concept will be presented, each having their own specific advantages. Since the improved method of controlling computing devices circuit has been described in detail and the following methods operate in much the same way, the following examples will be described in less detail but will be readily understood by those of ordinary skill in the art of electronic design.

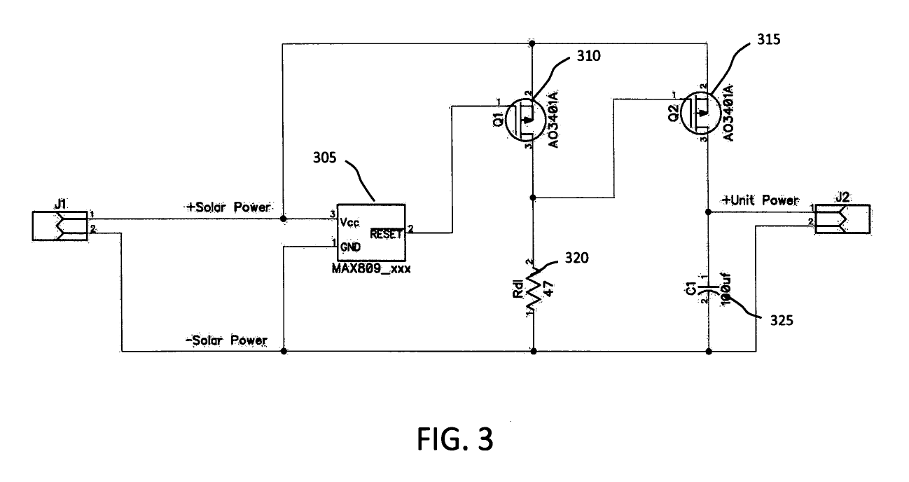

FIG. 3 shows a circuit for an improved method of controlling computing devices using a less-expensive and smaller pin count voltage supervisory circuit 305. The circuit in FIG. 3 is the preferred embodiment for applications where there is no control over the computing device other than powering it on and off. For example, in the Wi-Fi birdhouse, the Wi-Fi camera used is a commercially available Wi-Fi camera that is added to a birdhouse and powered by a solar panel. The camera has power and ground as the only inputs and it transmits video over Wi-Fi for its output. To make certain that the camera will operate properly each day the sun shines, the method described above is used to control the power to the device. Again, power will be applied to the device only after is has been determined that the solar panel has enough capacity to run the camera in operation.

As shown in FIG. 3, the voltage supervisor component 305 will assert _RESET (on pin 2 of the MAX809 device 305) when the voltage is below a threshold. The _RESET signal is applied to the gate of Q1 MOS-FET switch 310 and the MOS-FET switch 310 is on, effectively shorting the dummy load resistor 320 to +Solar Power. The high level on the gate (pin 1) of Q2 MOS-FET switch 315 keeps MOS-FET switch 315 turned off, keeping the computing device connected to J2 powered off. When the voltage (+Solar Power) rises above the threshold determined by the voltage supervisor component 305 the _RESET signal is turned off (goes high) and the voltage on dummy load resistor 320 drops to zero. The low voltage on the gate (pin 1) of Q2 MOS-FET switch 315 turns MOS-FET switch 315 on, powering on the computing device connected to J2. As described earlier, the power removal from the worst case load (dummy load resistor 320) allows the computing device to operate without dragging down the voltage from the solar panel. A filter capacitor 325 can be in place to suppress voltage transients on the output, but is not needed in every implementation of the circuit.

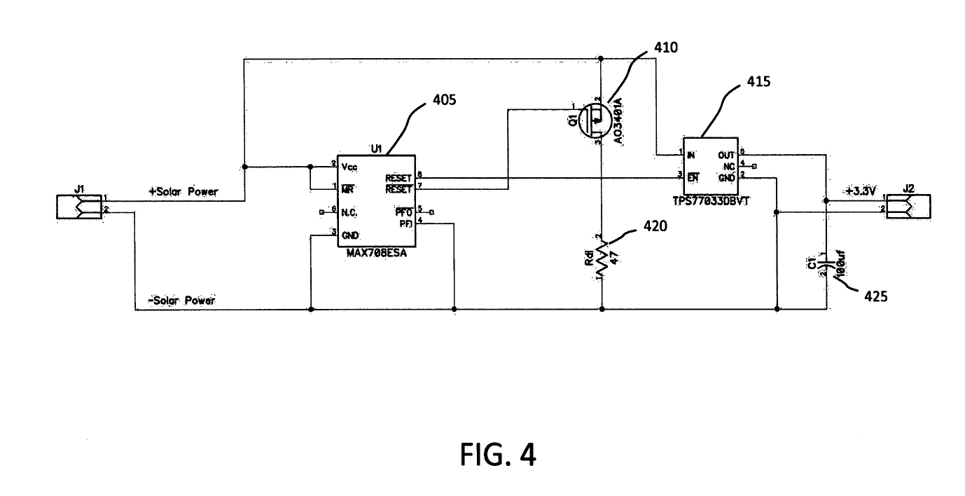

FIG. 4 shows a circuit for an improved method of controlling computing devices using a less-expensive and smaller pin count voltage supervisory circuit 405 as well as a voltage regulator with an Enable input. The circuit in FIG. 4 is the preferred embodiment for applications where there is no control over the computing device other than powering it on and off and the computing device requires a regulated voltage. Again, power will be applied to the device only after is has been determined that the solar panel has enough capacity to run the camera in operation.

As shown in FIG. 4, the voltage supervisor component 405 will assert _RESET and RESET when the voltage is below a predetermined threshold. The _RESET signal is applied to the gate of Q1 MOS-FET switch 410 and the MOS-FET switch 410 is on, effectively shorting the dummy load resistor 420 to +Solar Power. The high level on the low active _EN (pin 3) of voltage regulator 415 keeps voltage regulator 415 turned off, keeping the computing device connected to J2 powered off. When the voltage (+Solar Power) rises above the threshold determined by the voltage supervisor component 405 the _RESET signal is turned off (goes high) and the voltage on dummy load resistor 420 drops to zero. The complementary signal RESET goes low and the low voltage on the _EN (pin 3) of voltage regulator 415 enables the regulator output, powering on the computing device connected to J2. As described earlier, the power removal from the worst case load (dummy load resistor 420) allows the computing device to operate without dragging down the voltage from the solar panel. A filter capacitor 425 can be in place to suppress voltage transients on the output and would be good design practice when using a voltage regulator.

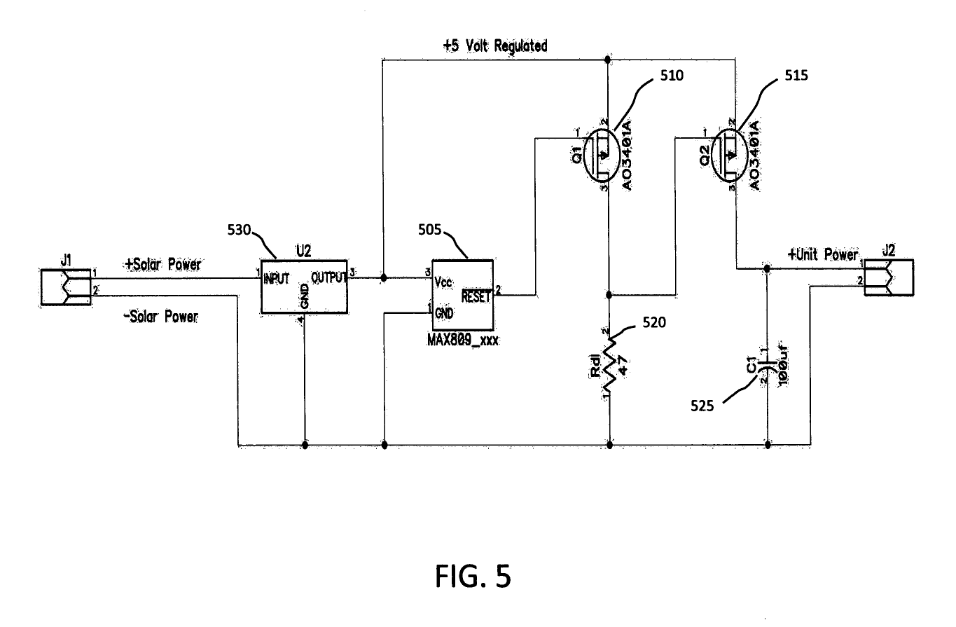

FIG. 5 shows a circuit for an improved method of controlling computing devices using a less-expensive and smaller pin count voltage supervisory circuit 505 as well as a voltage regulator 530 without an Enable input. The circuit in FIG. 5 is essentially the same circuit as shown in FIG. 3, but using a pre-regulated power source. Again, power will be applied to the device only after is has been determined that the solar panel has enough capacity to run the camera in operation and the applied power will be a known, regulated power source.

As shown in FIG. 5, the voltage supervisor component 505 will assert _RESET (on pin 2 of the MAX809 device 505 when the regulated voltage from voltage regulator 530 voltage is below a predetermined threshold. Even though the voltage from voltage regulator 530 is regulated, the voltage will be too low when the +Solar Power voltage is below the drop-out voltage of the voltage regulator 530.

The _RESET signal is applied to the gate of Q1 MOS-FET switch 510 and the MOS-FET switch 510 is on, effectively shorting the dummy load resistor 520 to +5 Volt Regulated. The high level on the gate (pin 1) of Q2 MOS-FET switch 515 keeps MOS-FET switch 515 turned off, keeping the computing device connected to J2 powered off. When the voltage (+5 Volt Regulated) rises above the threshold determined by the voltage supervisor component 505 the _RESET signal is turned off (goes high) and the voltage on dummy load resistor 520 drops to zero. The low voltage on the gate (pin 1) of Q2 MOS-FET switch 515 turns MOS-FET switch 515 on, powering on the computing device connected to J2. As described earlier, the power removal from the worst case load (dummy load resistor 520) allows the computing device to operate without dragging down the voltage from the solar panel. A filter capacitor 525 can be in place to suppress voltage transients on the output, but is not needed in every implementation of the circuit.

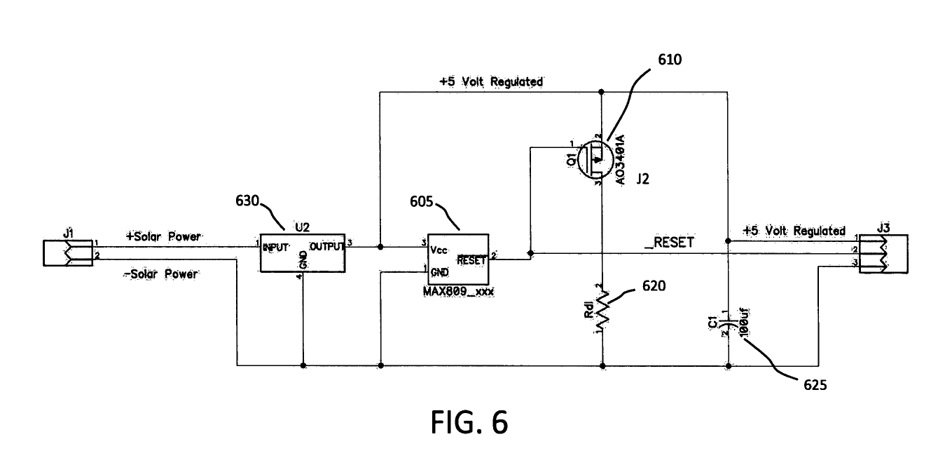

FIG. 6 shows a circuit for an improved method of controlling computing devices using a less-expensive and smaller pin count voltage supervisory circuit 605 as well as a voltage regulator 630 without an Enable input. The circuit in FIG. 6 passes the _RESET signal to the computing device to keep the computing device from operating until there is enough power to run the computing device. The circuit shown in FIG. 6 can be used when there is access to the _RESET signal of the computing device. Power will always be applied to the computing device and the voltage to the computing device will rise as the solar panel generates enough power to run the computing device. Only after is has been determined that the solar panel has enough capacity to run the camera in operation will the dummy load be released and the computing device allowed to operate.

The value for the dummy load resistor 620 is computed by using the difference between the reset state current draw of the computing device and the worst case current draw from the computing device when operating. In this example the voltage being applied to the computing device is 5 volts. Therefore, the dummy load resistor 620 value would be five (volts) divided by (worst case active current draw−lowest-case quiescent current draw).

As shown in FIG. 6, the voltage supervisor component 605 will assert _RESET (on pin 2 of the MAX809 device 605 when the regulated voltage from voltage regulator 630 voltage is below a predetermined threshold. Even though the voltage from voltage regulator 630 is regulated, the voltage will be too low when the +Solar Power voltage is below the drop-out voltage of the voltage regulator 630.

The _RESET signal is applied to the gate of Q1 MOS-FET switch 610 and the MOS-FET switch 610 is on, effectively shorting the dummy load resistor 620 to +5 Volt Regulated. The _RESET signal is passed on to the computing device through J2, keeping the computing device connected to J2 in an inactive (quiescent) state. When the voltage (+5 Volt Regulated) rises above the threshold determined by the voltage supervisor component 605 the _RESET signal is turned off (goes high) and the voltage on dummy load resistor 620 drops to zero. At the same time, the _RESET signal is turned off and the computing device is allowed to operate. Again, the solar panel will supply enough power to allow the computing device to operate normally. A filter capacitor 625 can be in place to suppress voltage transients on the output, but is not needed in every implementation of the circuit.

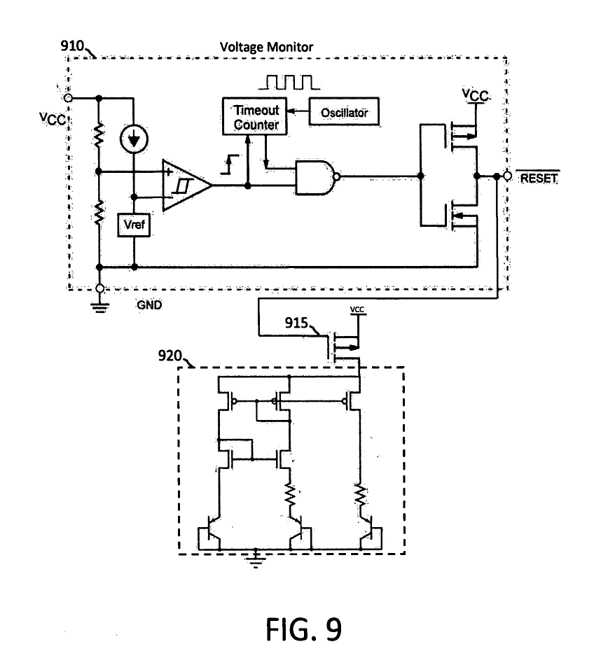

FIG. 9 is a representative schematic of the improved method of controlling computing devices circuit as it might be implemented on an Integrated Circuit. A circuit like the one shown in FIG. 9 could be implemented on an IC to give the IC itself the ability to be powered with an unreliable or unpredictable power source.

FIG. 9 contains a voltage monitor 910, a power MOS-FET switch 915 and a constant current load 920. The constant current load circuitry 920 replaces the resistive dummy load used in the previous examples, but otherwise operates on the same principles as the circuit in FIG. 6. The _RESET signal would be used in the remaining parts of the IC to hold off operation until the voltage monitor 910 detects enough power to run the IC in operating mode. The constant current load circuitry 920 would be designed to draw the difference between the worst case active current of the IC and the quiescent current of the IC.

It will be apparent from the foregoing that, while particular forms of the disclosure have been illustrated and described, various modifications can be made without parting from the spirit and scope of the disclosure.

Furthermore, the various embodiments described above are provided by way of illustration only and should not be construed to limit the invention. For example, while described as a solar powered Wi-Fi camera, embodiments are not so limited.

Essentially all computing devices powered from an unpredictable or unreliable power source could benefit from the improved method of controlling computing devices and circuitry. As an example, an integrated circuit (IC) could be designed with a circuit like the one shown in FIG. 9 and powered by a heat activated power source, such as from dissimilar metals. The IC could transmit a low power signal whenever heat causes the IC to have enough power to operate. Such ICs could be made as almost microscopic die that could be imbedded in paint, wallboard, insulation, etc. for use in home/commercial construction. Early fire detection could then be achieved by having a receiver in the building listening for the transmission of the fire activated signal. Since many, if not most, fires start inside the walls of buildings, such a technique could save lives and property.

Those skilled in the art will readily recognize various modifications and changes that may be made to the disclosed invention without following the example embodiments and applications illustrated and described herein.

I claim:

1) An electronic power control circuit comprising of:
a) a path for current through at least one dummy load that is separate from a path for current through at least one functional load, wherein said path for current through said dummy load is active until a predetermined amount of power is consumed by said dummy load;
b) a said path for current through a said functional load that is separate from a said path for current through a said dummy load wherein said path for current through a said functional load is inactive until a predetermined amount of power is consumed by said dummy load;
c) a power threshold detector that controls said path for current through a said dummy load and said path for current through a said functional load, wherein said power threshold detector turns on said path for current through a said functional load while turning off said path for current through a said dummy load when a predetermined power threshold is met;
d) and a said power threshold detector that controls said path for current through a said dummy load and said path for current through a said functional load, wherein said power threshold detector turns off said path for current through a said functional load while turning on said path for current through a said dummy load when a predetermined power threshold is no longer met.

2) The electronic power control circuit of claim 1, wherein:
a) said electronic power control circuit is powered by a solar panel.

3) The electronic power control circuit of claim 1, wherein:
a) said electronic power control circuit is powered by a solar panel;
b) and said functional load is a WiFi camera.

4) The electronic power control circuit of claim 1, wherein:
a) said electronic power control circuit is powered by a solar panel;
b) said dummy load is a resistive load;
c) said power threshold detector is a voltage monitoring circuit;
d) and said functional load is a WiFi camera.

5) An electronic power control circuit comprising of:
a) a path for current through at least one dummy load that is separate from a path for current through at least one functional load, wherein said path for current through said dummy load is active until a predetermined amount of power is consumed by said dummy load;
b) a said path for current through a said functional load that is separate from a said path for current through said dummy load wherein said path for current through said functional load is inactive until a predetermined amount of power is consumed by said dummy load;
c) a power threshold detector that controls said path for current through said dummy load and said path for current through said functional load, wherein said power threshold detector turns on said path for current through said functional load while turning off said path for current through said dummy load when a predetermined power threshold is met;
d) a said power threshold detector that controls said path for current through said dummy load and said path for current through said functional load, wherein said power threshold detector turns off said path for current through said functional load while turning on said path for current through said dummy load when a predetermined power threshold is no longer met;
e) wherein said dummy load is a solid state current sink.

6) The electronic power control circuit of claim 5, wherein:
a) said electronic power control circuit is powered by a solar panel.

7) The electronic power control circuit of claim 5, wherein:
a) said electronic power control circuit is powered by a solar panel;
b) and said functional load is a WiFi camera.

8) The electronic power control circuit of claim 5, wherein:
a) said electronic power control circuit is powered by a solar panel;
b) and said power threshold detector is a voltage monitoring circuit.

9) An electronic power control circuit comprising of:
a) a path for current through at least one dummy load that is separate from a path for current through at least one functional load, wherein said path for current through said dummy load is active until a predetermined amount of cumulative power is consumed by said dummy load and said functional load;
b) a said path for current through said functional load that is separate from said path for current through said dummy load wherein said path for current through said functional load is also active, wherein said functional load is held inactive via a separate control signal from a power threshold detector until a predetermined amount of cumulative power is consumed by said dummy load and said functional load;
c) a said power threshold detector that controls said path for current through said dummy load, wherein said power threshold detector turns off said path for current through said dummy load when a predetermined power threshold is met and said functional load is activated via said separate control signal from said power threshold detector;
d) and said power threshold detector that controls said path for current through said dummy load and said separate control signal to said functional load, wherein said power threshold detector turns off said separate control signal to deactivate said functional load while turning on said path for current through said dummy load when a predetermined power threshold is no longer met.

10) The electronic power control circuit of claim 9, wherein:
a) said electronic power control circuit is powered by a solar panel;
b) and said functional load is a WiFi camera.

11) The electronic power control circuit of claim 9, wherein:
a) said separate control signal to said functional load is a reset signal used to activate and deactivate said functional load.

12) The electronic power control circuit of claim 9, wherein:
a) said separate control signal to said functional load is a gated clock signal used to activate and deactivate said functional load.
